(19) United States
(12) Patent Application Publication
(10) Pub. No.: US 2002/0020135 A1
(43) Pub. Date: Feb. 21, 2002

(54) Device for the removal of squeaks in floors and in stairs

(76) Inventors: Orville Lehman Grove JR., Vinton, VA (US); Janice Marie Grove, Vinton, VA (US)

Correspondence Address: Orville L. Grove Jr., 917 Lauderdale Ave., Vinton, VA, 24179, US

(21) Appl. No.: 09/902,282

(22) Filed: Jul. 10, 2001

Related U.S. Application Data
(60) Provisional application No. 60/217,403, filed on Jul. 11, 2000.
(60) Provisional application No. 60/217,409, filed on Jul. 11, 2000.

(51) Int. Cl. E06B 3/54; E04B 9/00; E04B 1/38; E04C 5/00

(52) U.S. Cl. 52/702; 52/712; 52/698; 52/480

(57) ABSTRACT

Squeaks in floors or stairs will be eliminated by the usage of this device. By the usage of screws as fasteners, the ability of securing each to one another, works especially in a situation as this. The SQUEAKBUSTER device. It is a metal bracket invented solely for the purpose of removing squeaks in a floor system that is either in a residential or commercial structure. This device has a number of predetermined pattern of holes in the top flange, as well in the side flange areas. This bracket or system is to join two perpendicular members together, tightly where there has been a separation between the joists and subfloor, where there is a space or gap. Also in an area where the plywood is rubbing up against the shaft or staff of the nail. That is creating a squeak in the floor system. The system finds a particular application where it is desired to secure a subfloor the underlying joist to eliminate squeaking and to rectify a spongy feeling in the floor by providing strength in this area or simply with reinforcement. There are different forms or shapes of this device, that works in hand with different applications of the building material technology. Each application shall consist of a man made and formed bracket. Each device has two sides, that are at a ninety-degree angle to each other, that is able to correct any flaws in any floor system, due to any poor craftsmanship, materials used, any irregularities or misalignment during the drying out of a structure floor.

### CROSS-REFERENCE TO RELATED APPLICATIONS

This application the benefits of Provisional Patent Applications Ser. Nos. 60/217403 and 60/217409 filed on Jul. 11, 2000.

### FIELD OF INVENTION

This invention relates to any application of devices that would remove squeaks in floors or stairs. Especially where such problems do exist and repairs are inevitable.

### DESCRIPTION OF PRIOR ART

The use of such devices for eliminating squeaks in any wood surface member with a wide variety of designs and configurations is known to be as prior art. More specifically states devices with all factors included heretofore devised in utilized for the sole purpose of eliminating squeaky areas in constructed members through a variety of methods and apparatuses are known to consist basicall of familiar expected and obvious structural configuration not with standing the myraid of designs encompassed by what in this area known as prior art.

In this discussion over what is prior art we must look at what has been invented and usage of such art. There are many different designs and applications of such U.S. Pat. Nos. 5,372,466; 5,577,359 ; 5,497,593 ; 4,888,926; 5,497,593. Each having a different design as well purpose to application of such art. But some are simple and some complex time- consuming to install but all with the goal of trying to stop squeaks in floors. We will all agree that to remove any squeak in a floor system you must be able to bring back down the subfloor to make contact with the joist material. Whether it means the application is from below the floor such as the joist area or from above coming through the subflooring each of these have their drawbacks to prior art.

Before going into discussion of prior art I will bring up the issue of the present invention over prior art so there is no misunderstanding or conflict of prior art. It is not just limited to the design or materials but also how it works over existing prior art. But the ability to perform as claimed. The ability to pull back-down the subflooring and by securing the floor back into its original position and removing any space or gap that would cause a squeak by securing it so no movement would exist after repairs have been done.

First of all in previous art under U.S. Pat. No. 5,372,466 is or has been addressed by going in from the top. This patented invention states he can remove squeaks by snapping off the head and the threads of screw will remove the squeaks by securing the subflooring. This is not the problem the problem lies in or around that the area of joist and some subflooring locations. If the covering is that of hardwood floors You cannot truly locate the joists is especially if the area is finished underneath. Trying to locate the joist with a stud finder would make this installation harder because of the excessive amount of nails driven during the installation of the hardwood flooring. Thus this method is a hit and miss style.

First of all in previous art under U.S. Pat. No. 5,403,414 is or has been addressed by the use of strips of to act as a cushion but this was for usage during the original construction phase. Where one might believe that squeaks do occur but later down the road. Also in the factor the use of nails as fasteners would sit in. Thus creating the problem of squeaks plus the use of green materials in the warpage of joist material and Mother Nature complex still would create gaps thus it would not provide the ability to stop squeaks if the fasteners gave out thus only acting as a cushion.

First all in previous art under U.S. Pat. No. 5,577,359 is or has been addressed by the ability to pull down the subfloor. The ability of pulling down the subfloor between the two joist in this invention is truly and conceivably be the wrong way in dealing properly with squeaks for one reason. It fails to provide proper securing the subflooring to the joists. Especially if the area where this device became or where the subfloor became wet or rotted thus making this invention fail to hold and secure. Also not knowing how many to install to stop squeaks.

First all in previous art under U.S. Pat. No. 4,88,926 is or has been addressed by the use by the ability to pull down the subfloor. The ability of going down the subfloor by the use of the device which has three or four moving parts in this invention. The downfall of this is the ability to install quickly plus the massive amount of product used properly to remove squeaks in the floor system . Plus letting me squeaks appear and making this a hit and miss style of invention.

First all in previous art under U.S. Pat. No. 5,497,593 does bring up the installation of a metal bracket that has that slips into the gap in the area where the squeak is located. The drawback to this is that it can make squeak travel if it is forced into a smaller gap.

### ATTACHMENT TO PRIOR ART

In this respect accordingly to the present invention substantially departs from the conventional concepts and designs of prior art by the material used in the design of the present invention. And provide a device primarily developed for the purpose of eliminating squeaks and houses and buildings through the use of a simplified bracket.

Therefore he can be appreciated that there exists a continuing effort and need for a new improved inventions which can be used on floors by eliminating squeaky floors in homes or buildings where this problem exists through the use of the metal bracket device system. In this regard the present day invention substantially fulfills this need.

### BACKGROUND OF THE INVENTION

In the construction of buildings the floor are frequently installed by supporting a deck on top of a series of floor joists that have a layer of plywood. The deck it is usually fabricated from wood products and are usually fastened to the underlying joist by means of nails. It to is very common to have two substantially perpendicular members joined in the construction of houses and other types of buildings where wood is used in the floor or stairs construction in which the plywood substrate has separated from the wood joist material in which it has been fastened with nails. However overtime the woods of subfloor has become separated from the joist either through warpage or shrinkage and is somewhat raised above the joist at any given time do to the floor being wet and then drying out.

Two common problems that exist. First the floor tends to squeak when walked upon in response to the weight being placed upon the plywood subfloor. Secondly the squeak results when it is due to the wood surrounding the nail rubs up against the shank of the nail in response to the weight. This is known to be a spoungy floor area.

Due to the increasing expense and difficulty of obtaining fully seasoned wood products there has been an increasing tendency to install joist which are not as fully seasoned nor perhaps as true as the builder might otherwise like. Unfortunately once the wood fully dries its curvature often changes and the resulting irregularities and misalignment of the edges of the joist with the underlying plywood frequently results in the and numerous floor squeaks in the finished building. The squeaks often occur due to the plywood rubbing up and down against the shaft of the nail which did fastened the plywood to the joist. The gap between the top of the joist and the plywood which permits the plywood to flex up and down as a person or other objects move across the floor where the squeak is located at.

The conventional measure which has been adopted in the construction industry in an attempt to overcome this problem of floor squeaks is to include the plywood sheets directly to the joists using some kind of adhesive or glue. This technique has been marked by and very modest success. Very commonly once the wood as dried out the resulting irregularities and misalignments become so great that the glue dries and simply cracks or breaks and does nothing to stop the squeaks or the squeaks in the floor system. With mother nature working against the installation of this is predominante that this problem will occur if it is raining or wheather is hot or cold.

The squeaky area in a structure subject to traffic is an indication of poor quality in that structure. In fact it is quite possible to say that a floor or stairs is completely undesirable. Whether that indication of poor quality is accurate or merely perceive it is highly desirable to eliminate the squeaky area accurately and efficiently. A squeaky floor it's truly highly undesirable. This logic apply to the squeaky stairs because this is another area in a structure were squeaks do exist and he will have a weight transfer at different amounts of force in different amounts of poundage per square foot. So because of this you must conclude that this area is highly undesirable. Yet it is extremely difficult to provide a squeak proof floor or stairs. Even with or even if extra care is taken during construction to avoid such occurrences shrinkage for expansion a materials there can be areas where squeaks might form. In a floor system over time the wood shrinks or expands thereby changing the structure of its original joist. Thus if the fasteners were to be a nail it was to become loose creating a chance to produce a gap thus creating the squeak. Anyone or a combination of these changes can create a space or gap. This space between the floor area such as subfloor to the joist can cause a squeak when pressure applied to the area surrounding the space. In a similar fashion a squeak can occur in a staircase. And the weight can be from the pressure of walking or putting heavy objects in which the floor wasn't designed for. Also the age of the floor has bearing weight. Once the squeak occurs it is extremely difficult to eliminate the squeak from the structure. But it can be done by using different ideas through different means and technology.

### SUMMARY OF THE PRESENT INVENTION

The present invention known as a device which would be a metal bracket to provide a system for securing and conveniently drawn together the bottom working surface of the wood member known as the subfloor and the top working surface of the wood member known as the joist. Also this device can be used in bracing in the area stairs known as treads and risers.

The device of this system consists of a man-made formed metal bracket and fasteners known as screws for attaching to these locations in the floor or stairs locations were a squeak may occur or even exist. If the bracket is preferably composed out of metal such as steel. The device has two working surfaces comprising of a pair of flange surfaces that meet to form a ninety-degree angle to the working surfaces. These working surfaces mate with one side of the area known as the joist and the area of the bottom surface of the area known as subflooring and adjacent to the joist. The ninety-degree construction of the bracket enables it to meet flush with the intersection of the perpendicular planar location of both the joist and subfloor requiring the attention in the area of floor squeaks.

With the installation of the device and the mounting of said such a device it will pull downward any such gaps between the subflooring and the joist any gap that separates or may exist due to poor workmanship warpage shrinkage use of not fully seasoned materials settle of the building any other reason for having squeaks or spongy floor area. Because of the top flange or flange that is under the subfloor is fitt horizontally with respect to the subfloor. The top flange acts like a stiffener in the repairs to the floor especially in a area referred as spongy.

The device is vas superior to toe-nailing or scabbing a stiffener board trying to stop the squeak. Also it should be mentioned the usage of wood shims makes this superior to repairing the squeaks by this present invention. Over prior art you must look at each prior art and evaluate each one to the present invention. But finally you must look at the scope of the present invention and the design of it. There are many varieties to it with the manufacturing concept for different applications to the different technological aspects of building materials especially in the joists. Plus the thickness of materials used thus creating different products from the present invention. Meaning by inserting a strip of material whether it is simply a strip of steel or by forming a design with ribs or bending another angle to the bracket for a different joist application all these factors create the vast superiority due to the ability to pull down or pullback the subfloor into the original position and securing it. With the predetermined locations of the holes in the flange you create a superior holding pattern for a bracket thus you eliminate the possibility of having any squeaks materialize after the repairs have been done.

### BRIEF DESCRIPTION OF THE DRAWINGS

The present invention will be more fully understood by the reference to the following detailed diagrams as described as: each application of the following and its design.

FIG#1: This is a partial of floor elevation of present invention named SQUEAKS-BE-GONE

FIG#2: This is a partial of floor elevation of present invention named SQUEAKS-NO-MORE

FIG#3: This is the top flange showing the locations predetermined mounting holes shown

FIG#4: This is a side plan view of the manufacturing concept designed of present invention named SQUEAKS-BE-GONE.

FIG#5: This is a side plan view of the manufacturing concept designed of present invention named SQUEAKS-NO-MORE.

FIG#6: This is a frontal plan view of side flange showing the locations of predetermined mounting holes shown of the present invention named SQUEAKS-BE-GONE.

FIG#7: This is a frontal plan view of side flange showing the locations of predetermined mounting holes shown of the present invention named SQUEAKS-NO-MORE.

### DETAILED DESCRIPTION OF THE INVENTION

Referring now to the drawings of seven and embodiments of that inventions known as product of SQUEAKBUSTER which is structured in accord with the present invention solely filed under Provisional Patent Applications filed on dates of Jul. 11, 2000.

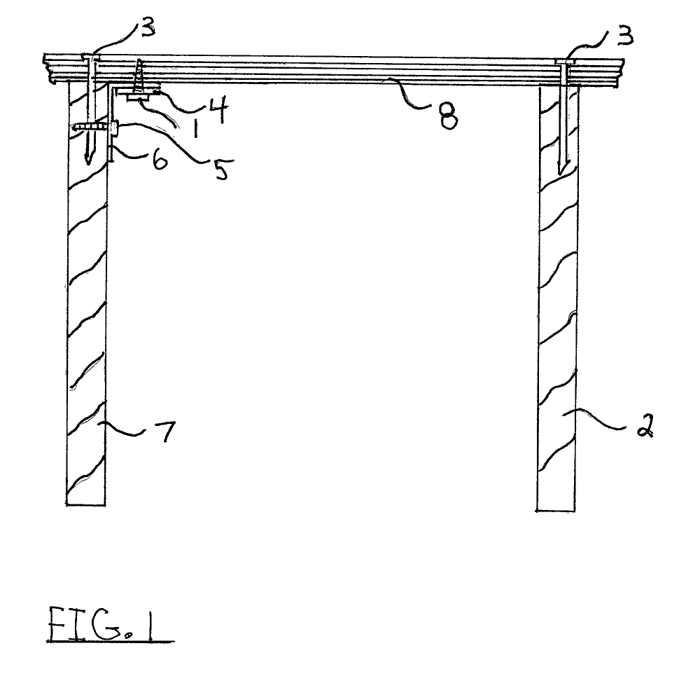

Referring now to a FIG. 1. there is shown one embodiment of invention named as SQUEAKS-BE-GONE structured in accord with present invention and as disposed in use. Shown in FIG. 1. is a portion of floor which includes a deck 8 and a pair of the subjacent floor joists #2&7. The floor deck 10 is supported in direct contact with the first joists 7 and is affixed thereto by a nail 3 shown here in the diagram. A second portion of the foredeck 10 shows a small gap in the area of joist 2. It will be noted that the floor deck 8 does not rest in contact with the second joist 2 but rather there is a gap there between. It is this gap that will produce a squeak or a spongy feel to the floor. When weight is placed on this floor deck 8 in the region of the second joist 2 the weight will drive that deck 8 against the upper surface of the joist 2 and the floor may squeak either as a result of wood rubbing then nail 3 or wood rubbing against other pieces of wood.

Referring to the location of the bracket installed on joist 7 you can see how the bracket is installed up against joist 7 and the deck 8 along with part of the bracket against each working surface in the floor system. By seeing each component you can see how each works with the other. Such as side flange 6 lays up against joist 7 with fastener 5 in being a screw that is one and one-quarter inches long at three or six on a screw with a length of three-quarter of an inch set at three inches on center. By setting the bracket on the side flange and securing it to the joist 7 you and then can install the screw thus pulling back down the deck 8 into its original position.

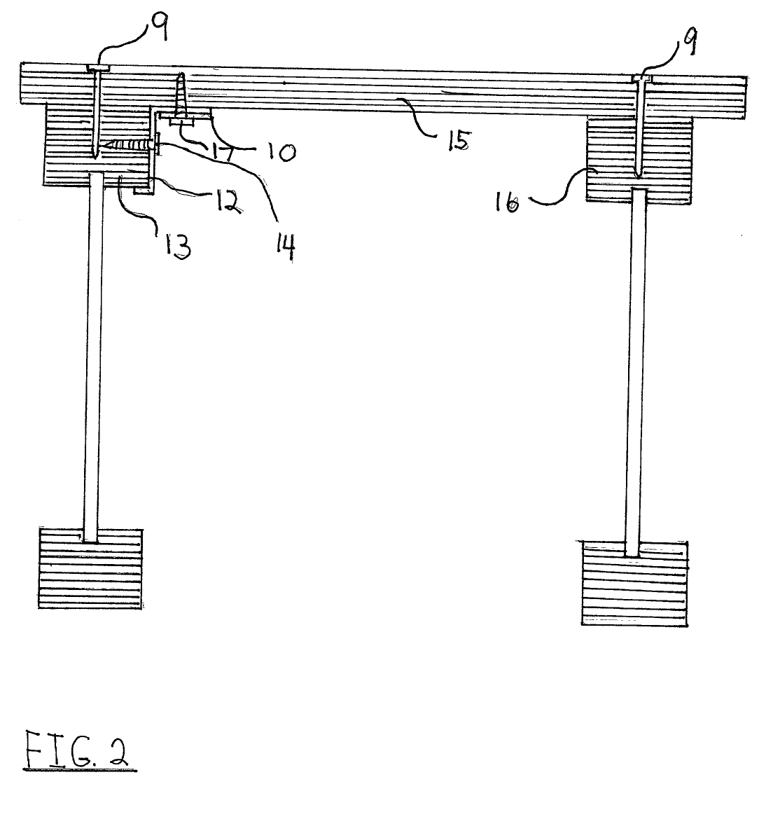

Referring now to FIG.2 there is shown one embodiment of invention named as SQUEAKS-NO-MORE structured in accord with present invention as disposed in use. Shown in FIG. 2 is a portion of a floor which includes a deck 15 and a pair of subjacent man made floor trusses referred as TJI's or BCI's 13 & 16. The floor deck 15 is supported in direct contact with the first truss 13 and is affixed thereto by nail 9 shown here in the diagram. A second portion of the floor deck 15 shows a small gap in the area of joist 16 but rather there is a gap there between. It is this gap that will produce a squeak or spongy area to the floor. Whenever weight is placed on this floor deck 15 in the region of the second joist 16 the weight will drive the deck 15 against the upper surface of the joist 16 and the floor may squeak either as a result of wood rubbing up against the nail 9 or would rubbing up against other pieces of wood.

Referring to the location of the bracket installed on the joist 13 you can see how this bracket is installed up against joist 13 and deck 15 along with part of the bracket against each working surface in the floor system. By seeing each component you can see how each part of the bracket works each other. The side flange 12 lays up against the top cord of truss 13 with a fastener 14 which is a screw that is one and a quarter inches in length and set at three or six inches on center. Also the top flange 10 lays up against the deck 15 with fastener 17 which is three quarter of an inch in length and is spaced on three inches on center. By setting the side flange first during installation to the joist 13 you'll have the pulling power to pull backdown the deck 15 so no space or gaps will exist thus removing and securing each perpendicular planar working surface together.

Referring to FIG. 3. Shows the top flange of both the SQUEAKS-BE-GONE and SQUEAKS-NO-MORE. This shows the layout of the predetermined mounting holes. By showing it as the top flange 19 there is no confusion to which invention exist. The mounting holes 20 are for a #8 size fastener.

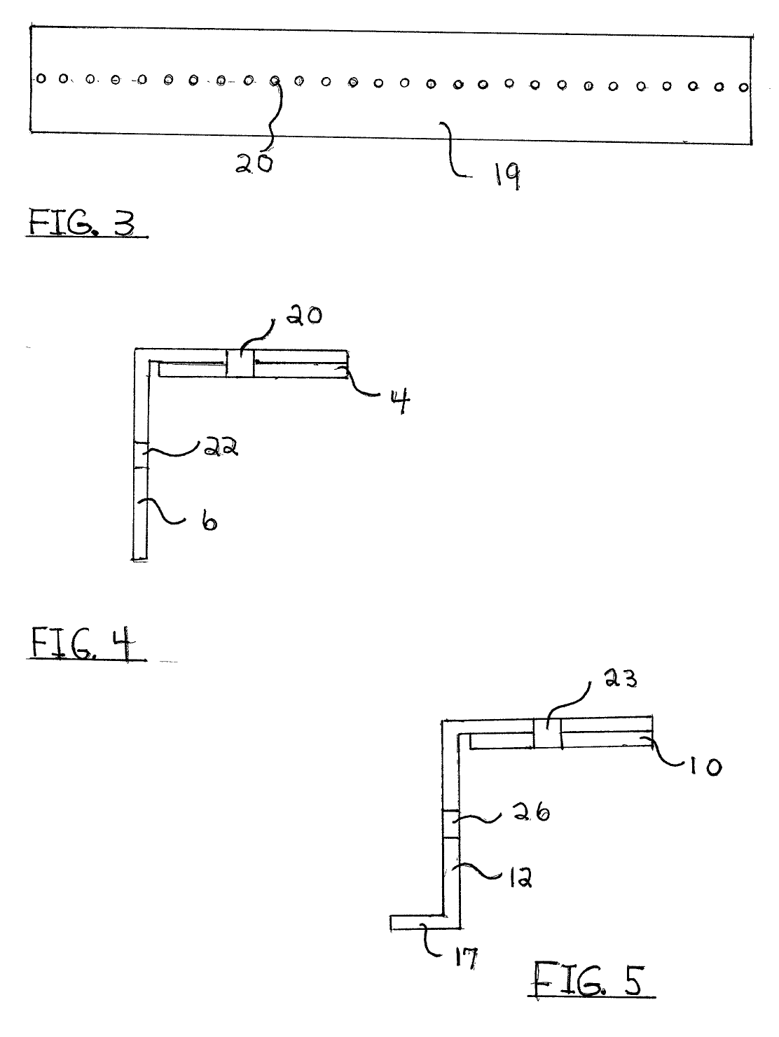

Referring to FIG. 4. This shows a side view of the invention shown in FIG. 1. The top flange area 4 shows the double thickness in this area. The mounting holes 20 is exactly in the middle of the bracket to evenly adjust the area where pulling is designed. The side flange 6 with mounting holes 22 is also exactly in the middle of the bracket so when mounting it gives it no chance of pulling out.

Referring to FIG. 5. This shows a side view of the invention shown in FIG. 2. The top flange area 10 shows the double thickness in this area. With the double thickness of material used this gives the ability to pull together any gap or space in an area where a squeak may exist. Mounting holes 23 are located exactly in the middle of the bracket to evenly adjust the area where the pulling is designed. Looking at the side flange 12 with the lower angle set flange 17 this helps set this bracket in place and act as a lever so there is no chance of pullout.

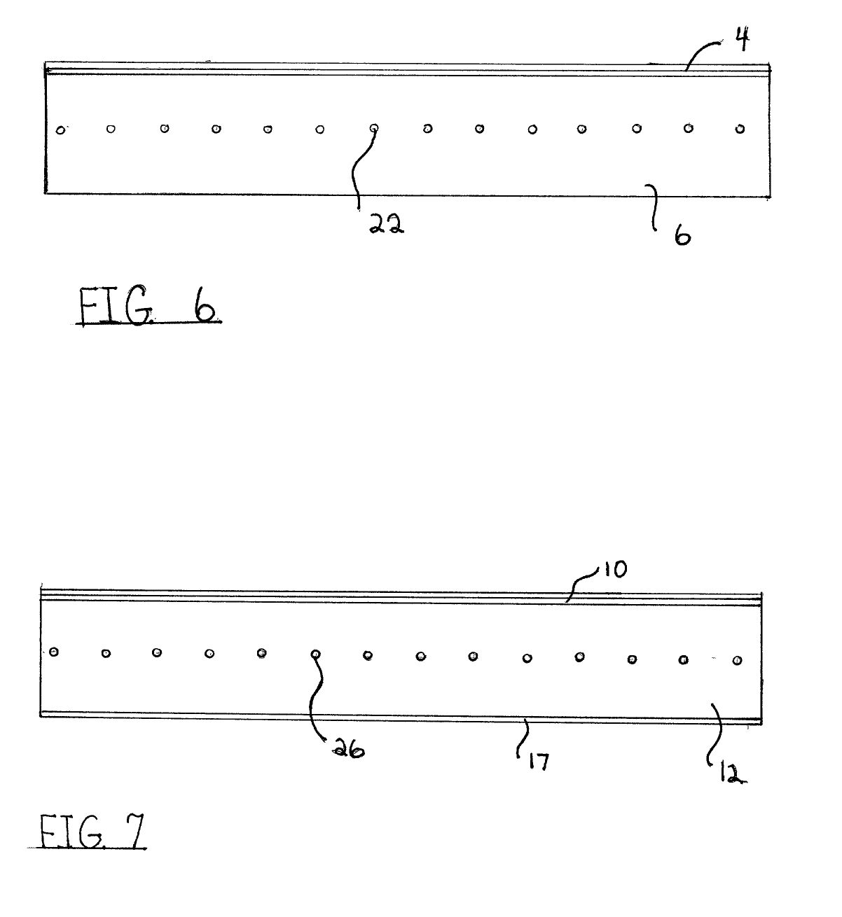

Referring to FIG.6. This shows the frontal plan view with the mounting holes 22 which are located at six inches on center. This is referred to invention known as SQUEAKS-BE-GONE. It shows the top flange 4 side flange 6 and mounting holes 22.

Referring to FIG. 7. This shows the frontal plan view with the mounting holes 26 which are located a six inches on center. This is referred to invention known as SQUEAKS-NO-MORE. It shows the top flange 10 side flange 12 and the bottom lip 17 area which is referred as the set angl lip.

### OBJECTS AND ADVANTAGES

Accordingly to objects and advantages and all devices or inventions for the eliminating of squeaks in floors describe in my inventions:

To provide an invention that has the ability to pull down the subfloor back into its original position and securing it permanently with fasteners that will not pop out or give away with time such as nails.

To provide an invention that is simple to install with limited amounts of skill.

To provide an invention that is lightweight to install.

To provide an invention that has many different designs to adapt to a certain installation problems and factor pertaining to the removal of squeaks in floors or stairs.

To provide an invention that will cover more square footage of floor space making it cost-effective.

To provide an invention that will not be based on a hit and miss concept of repairing squeaks in floors.

To provide an invention that its usage in materials in the present invention plus its different design actors can make this invention vastly superior to other inventions.

Further objects and advantages are to provide an invention which will be used to stop squeaks in floors that will be cost effective to other product that are offset by design and the usage of materials when they become available in the manufacturing of present invention. By using other factors plus fasteners will make any invention have the ability to pull down to each perpendicular planar of component and securing each to the opposite holding them solidly to one another without the fear of failure of such a device in which the present invention was designed for.

1. A device and system for drawing a first and second substantially perpendicular components together. Said the first component having a side and the second component having a top saying such system consisting comprising of:
A device known as a bracket having a first working surface for mating with a side member of wood is known as a joist to the first component. And a second working surface for mating with the underside member of wood is known as a subfloor to the second component. Thus in the system in a building of a floor. Each member of the floor substantially the define an as a perpendicular planar surfaces citing it's meaning as the following: Meeting of any given lines or surfaces at right angles thus giving this as a true ninety-degree surface shape defined or known as a true the planar surface. Thus giving the ability of such bracket to correct any flaws or correct any irregularities in correcting to create a concept of planar configuration. Ability to fasten means for attaching the device was to screw in each flange to each surface of perpendicular planar wood members of a floor system. In which this device was designed for thus giving the ability to secure the perpendicular flange to each corresponding surface of a floor system. Each flange has a different length of fastener.

2. The device known as a bracket where each flange of the device is at a true ninety-degree angle to each other has the ability to remove squeaks and pull each of the working surface back into a true ninety-degree angle to each other in by bending one of the manufacturing edges underneath the top flange area this process increases the pulling power of the bracket. With this area and the other design factors by adding more metal in the design factor you increase the strength of the top flange making it a superior product to the customer.

3. The system of this device does claim that in its design and locations of the predetermined holes whether in the top or side flange area does give the ability to hold and pulldown all materials that form a perpendicular planar configuration of a floor system. With the top flange having a wide width it gives structural strength to all along the joists and under the subfloor. Along with the locations of the predetermined holes it is our belief that with this spacing at a 3″ on center in each hole of the top flange with a fastener installed not only would the bracket having a superior holding power. But also there would not be able to produce any squeaks between the fastener locations. Also with the locations of the predetermined holes in the side flange it is our belief that this spacing at a three or six inches on center this also would have a holding power vastly superior between the device and the joist.
